(19) United States
(12) Patent Application Publication
(10) Pub. No.: US 2003/0180567 A1
(43) Pub. Date: Sep. 25, 2003

(54) Shape metal alloy tendon with swaged ends

(76) Inventors: James P. Dunne, Ballwin, MO (US); Mark A. Hopkins, Dayton, OH (US); Kevin J. Kilian, Kirkwood, MO (US); Dale M. Pitt, Afton, MO (US); Edward V. White, Charles, MO (US)

Correspondence Address: BLACK LOWE & GRAHAM PLLC, 816 Second Avenue, Seattle, WA, 98104, US

(21) Appl. No.: 10/105,036

(22) Filed: Mar. 20, 2002

(51) Int. Cl. B32B 1/04; B32B 15/01

(52) U.S. Cl. 428/583; 428/600; 148/402

(57) ABSTRACT

A shape metal alloy tendon and method for forming shape metal alloy tendons is presented. The shape metal alloy tendon has a shape metal alloy wire with an axis and a first and second end. A first metal sleeve is swagedly affixed to the first end. A second metal sleeve is swagedly affixed to second end.

### GOVERNMENT LICENSE RIGHTS

This invention was made with government support under US Government contract MDA972-97-3-0016 awarded by DARPA. The Government has certain rights in this invention.

### FIELD OF THE INVENTION

This invention relates generally to actuators and, more specifically, to deployment of shape memory alloys as actuators.

### BACKGROUND OF THE INVENTION

Shape Memory Alloys (SMA), such as Nickel-Titanium based alloys, exhibit unique characteristics as such alloys go through a phase change from a Martensite state to an Austenite state. The phase transformation can be either temperature induced or stress induced. Where the “trained” shape is a rod, the change of phase is demonstrated by the contraction of that rod. This contraction allows the SMA rod to be used as an actuator.

To exploit this quality of SMA, the SMA is commonly formed into wires with ends to which sleeves are affixed either by crimping on to the end or by tightening an internal setscrew. These ends allow the fixture of the wire between fixed points and control horns.

SMA is difficult to draw because either stress or heat will cause the phase change from Martensite state to an Austenite state. For this reason, SMA wires have generally been available in very small diameters of approximately 20 mils. As SMA wire drawing techniques have become more sophisticated, however, thicker wires have become available. These thicker SMA wires have proven capable of exerting stresses in excess of the fixation ability of the current means for fixation either by crimping or by setscrew. The greater exerted stress by the SMA wires has caused point loading of the setscrew or crimp and intense stress risers in the wire at the setscrew or crimp.

To overcome the shortcomings of setscrew and crimp fastening, casting ends on wire has been tried. When casting ends on the SMA wires, the heat of the casting has caused the SMA wires to lose the shape memory qualities. Casting has not produced reliable tendons.

Thus, there exists an unmet need in the art for producing SMA tendons that will withstand greater tension forces than greater tension forces presented by thicker SMA wires.

### SUMMARY OF THE INVENTION

The present invention provides shape metal alloy (SMA) tendon and method for forming SMA tendons. The SMA tendon has a shape metal alloy wire with an axis and first and second ends. A first metal sleeve is swagedly affixed to the first end. A second metal sleeve is swagedly affixed to the second end.

According to another aspect of the invention, a method is provided for forming SMA tendons. A SMA wire having an axis and a first and second end is provided. A first tubular ferrule is provided. The first end is inserted through the first ferrule. The first ferrule is swaged onto the first end. A second tubular ferrule is provided. The second end is inserted through the second ferrule. The second ferrule is swaged onto the second end.

The SMA tendons provide a compact, low cost, and reliable mechanical termination that can withstand repeated application of high force and thermal cycling. Because the SMA is actuated in such an environment, the inventive tendon is well adapted to SMA use. The SMA swaging provides fastening in a manner that is compatible with compact means for providing electrical isolation of the SMA wire or rod.

As will readily be appreciated, unlike the casting of rod ends using molten metals, swaging can be accomplished at much lower temperatures thereby avoiding the phase change from Austenite to Martensite.

The swaged wire retention works for both low and high force wires or for rods. Swaging affixes the sleeves on the end with uniform radial compressive forces. These forces are distributed over a larger area than the point loading of set screws or of crimping and do not induce stress risers in the wire. As commonly practiced, swages have the potential of approximately 8-fold improvement in wire retention over either set screws or crimping.

Swaging allows for exceptional dimensional control, superb surface finishes, and requires no removal of waste metal. Working the metals by swaging actually hardens the material thereby increasing its strength. Swaging is a highly repeatable practice.

### BRIEF DESCRIPTION OF THE DRAWINGS

The preferred and alternative embodiments of the present invention are described in detail below with reference to the following drawings.

FIG. 1 is a side view of a shape metal alloy wire;

FIG. 2 shows radial and axial views of a sleeve to be affixed by swaging on the end of an SMA rod;

FIG. 3 is a plan view of a resulting swaged end in the aerospace ball configuration;

FIG. 4 is a perspective view exemplary of swaging hammers exerting radial force on the sleeve;

FIG. 5 is a plan view of one preferred embodiment of the resultant SMA tendons showing cylindrical swaged termination;

FIG. 6 is a plan view of one preferred embodiment of the resultant SMA tendons showing aerospace ball swaged termination; and

FIG. 7 is a flow chart for a method of swaging ends onto SMA wire.

### DETAILED DESCRIPTION OF THE INVENTION

The present invention provides shape metal alloy (SMA) tendon and method for forming SMA tendons. The SMA tendon has a shape metal alloy wire with an axis and first and second ends. A first metal sleeve is swagedly affixed to the first end. A second metal sleeve is swagedly affixed to the second end.

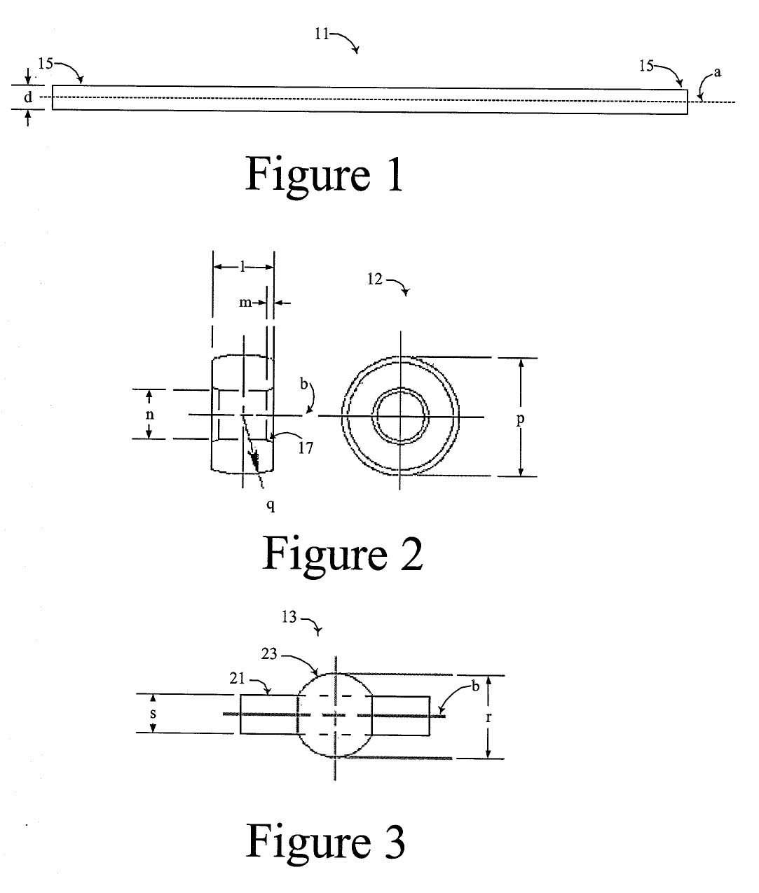

FIG. 1 displays a shape metal alloy (SMA) wire 11 having an axis a, a diameter d, and two ends 15. As is known, SMA is valuable because of its ability to change phase when triggered by heat. The heat of working the SMA may also trigger this phase change. Casting will also heat the SMA and trigger the phase change.

Advantageously, swaging a sleeve does not require heating the sleeve material to mold it around the SMA wire 11. The swaging process can be controlled in a manner to produce temperatures consistent with the pliable phase of the SMA wire 11. Swaging is suitably performed in any acceptable, known manner in the art. Because swaging is well known, further discussion of a swaging process is not necessary for an understanding of the invention. This optimizes the contact between the SMA wire 11 and the sleeve (not shown) affixed thereto.

FIG. 2 displays a sleeve 12 that has not been hammered to form a swaged end. The sleeve 12 is alternately displayed in a radial and an axial views of the same sleeve 12. The sleeve 12 has a principal axis b. A first dimension of importance is n, the inside diameter of the sleeve 12. Optimally, this diameter n is only slightly greater than the diameter d of the SMA wire 11 (FIG. 1) that will be placed inside. To ease the insertion of the SMA wire 11 (FIG. 1) into the sleeve, a chamfered bevel having width m is provided. While not necessary, utility of the bevel 17 is readily perceived by those skilled in the art.

The remaining three dimensions of the sleeve 12 are suitably selected to ensure that the volume of material present is adequate to suitably perform swaging of the end. These dimensions are: the axial length 1, the radial profile q, and the outer diameter p. Because swaging will alter suitably the final profile of the sleeve 12, the purpose of the selected radial profile q is suitably selected to assure adequate volume to achieve a proper distribution of the material when swaged.

FIG. 3 shows the finished swaged end 13 in an aerospace ball configuration. As shown, the finished swaged end 13 around the SMA wire 11 (FIG. 1) is a composite of two profiles, that of a cylinder 21 with the axis b and with an outer diameter s, and that of a sphere 23 with radius r. The cylinder 21 extends axially, covering the SMA wire. The sphere 23 is placed in such a fashion as to achieve an optimal length. The outer diameter s and the radius r are suitably selected accorded to the intended application.

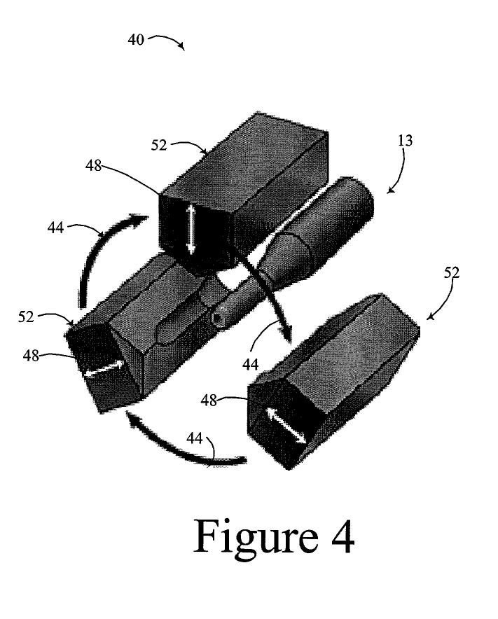

FIG. 4 displays an apparatus 40 to perform the process of rotary swaging. Rotary swaging is the most common method of swaging. It will be readily appreciated by those in the art that any suitable swaging method such as plunge swaging or the like are suitably used according to the invention.

The apparatus 40 consists of hammering dies 52 arranged to work a sleeve 12 to produce a swaged end 13. Not shown are the means for driving the hammering dies in oscillation along a radian indicated by an arrow 48 and means for rotating the dies about the sleeve according to an arrow 44 such that the centrifugal force drives the dies outward after each hammering strike. Such means are known and readily supplied by those skilled in the art.

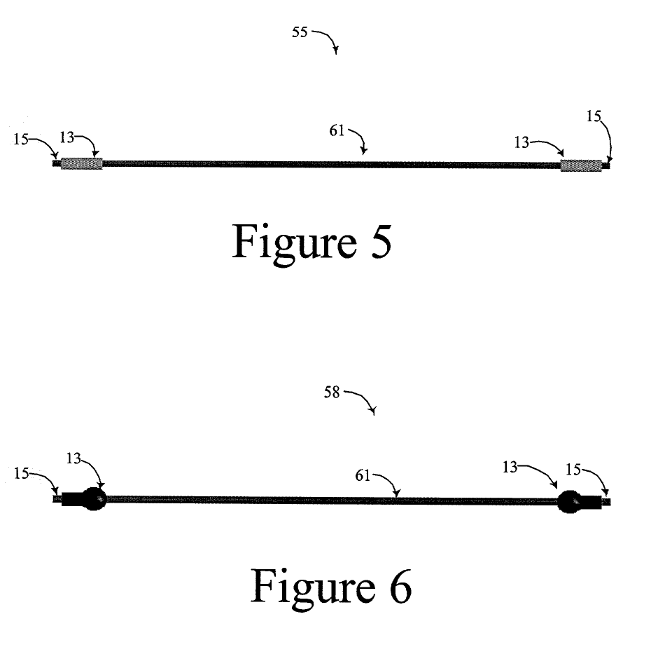

FIG. 5 shows a preferred embodiment of the SMA tendon 55. SMA tendon 55 has finished swaged ends 13 that are cylindrical in form. To actuate the SMA tendon 55, the tendon 55 is suitably heated. One presently preferred method is to pass a suitable electrical current through the SMA tendons 55. However, as will readily be appreciated by one skilled in the art, any suitable source of heat will actuate the SMA tendon 55. When, actuated, the SMA tendon 55 will change phase from its Martensite state to the Austenite phase, and will contract to recover any strain and return to a trained shape. In terms of stress recovery, which is the mechanism that produces force, the SMA tendon 55 also changes its modulus in the course of the phase change. The SMA tendon 55 pull the finished swaged ends 13 toward each other.

FIG. 6 shows one presently preferred embodiment of the SMA tendon 58 according to the invention. The SMA tendon 58 has finished swaged ends 13 that are in the form of an aerospace ball. As will readily be appreciated by one skilled in the art, the form of the swaged end 13 may be varied suitably to accommodate the application to which the SMA tendon 58 is applied. Examples of such various forms include a pyramidal end, a wafer end, and a conical end.

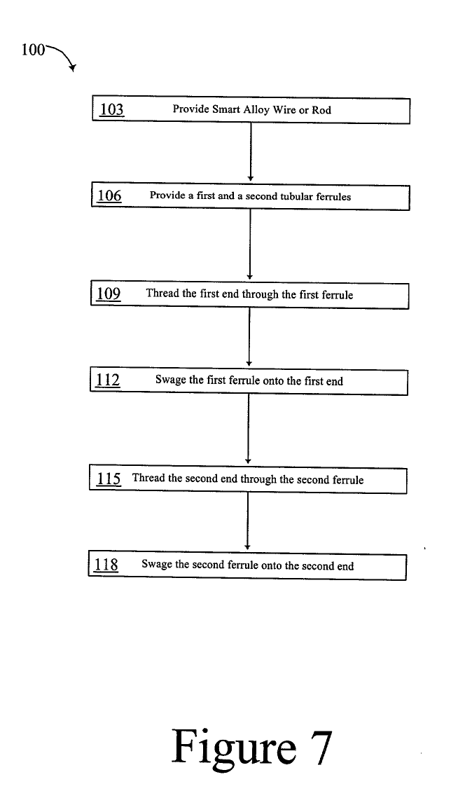

FIG. 7 portrays the flowchart of a method 100 used to produce the swaged end tendon according to the invention. To produce an SMA tendon 55 (FIG. 5) or 58 (FIG. 6), an SMA wire 11 or rod of suitable dimensions 103 is provided at a block 103. The diameter d of the wire or rod is selected according to the desired actuation force. Wires of greater diameter can exert greater force. Further, the length of the SMA wires is suitably selected according to the range of contraction desired from the actuator. In one embodiment, wire lengths are suitably selected to allow variation between filly extended and fully contracted lengths of approximately four percent. It will be appreciated that greater or shorter variation may be used as learned for a particular application. Greater variation will result in a shorter reliable lifespan. Shorter variation will result in a longer reliable lifespan.

At a block 106, sleeves or ferrules 12 are selected for swaging onto the ends of the SMA wire. Ferrule material must be sufficiently malleable for swaging and is usually selected to prevent interaction between the SMA wires during the life cycle of the SMA tendon. This material selection is well known to those skilled in the art.

At a block 109, the first sleeve is inserted onto the first end of the SMA wire. At a block 112, the sleeve is swaged onto the SMA wire to produce a swaged end. At blocks 115 and 118, the processing of blocks 109 and 112 is repeated for the remaining end. The result is a swaged tendon suitable for uses as an actuator in SMA applications.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed:

1. A smart metal alloy tendon, the tendon comprising:
an SMA wire having an axis a first end and a second end;
a first metal sleeve swagedly affixed to the first end; and
a second metal sleeve swagedly affixed to the second end.

2. The tendon of claim 1, wherein the first and second metal sleeves are swagedly affixed by rotary swaging.

3. The tendon of claim 1, wherein the first and second metal sleeves are swagedly affixed by plunge swaging.

4. The tendon of claim 1, wherein the first and second metal sleeves are swaged to produce a cylindrical swaged end.

5. The tendon of claim 1, wherein the first and second metal sleeves are swaged to produce a conical swaged end.

6. The tendon of claim 1, wherein the first metal sleeves are swaged to produce an aerospace ball swaged end.

7. The tendon of claim 1, wherein the first metal sleeves are swaged to produce a pyramidal swaged end.

8. The tendon of claim 1, wherein the first metal sleeves are swaged to produce a wafer swaged end.

9. A method for forming shaped metal alloy tendons comprising:
providing a smart metal alloy wire having an axis and a first and second end;
providing a first tubular ferrule;
inserting the first end through the first ferrule;
swaging the first ferrule onto the first end;
providing a second ferrule inserting the second end through the second ferrule; and
swaging the second ferrule onto the second end.

10. The method of claim 9, wherein swaging includes swaging the first and second ferrules by rotary swaging.

11. The method of claim 9, wherein swaging includes swaging the first and second ferrules by plunge swaging.

12. The method of claim 9, wherein swaging includes swaging the first and second ferrules by to form a ball end.

13. The method of claim 9, wherein swaging includes swaging the first and second ferrules by to form a cylinder end.

14. The method of claim 9, wherein swaging includes swaging the first and second ferrules by to form a pyramidal end.

15. The method of claim 9, wherein swaging includes swaging the first and second ferrules by to form a conic end.

16. A smart metal alloy tendon, the tendon comprising:
an SMA wire having an axis a first end and a second end;
a first metal sleeve swagedly affixed by rotary swaging to the first end to form an aerospace ball end; and
a second metal sleeve swagedly affixed by rotary swaging to the second end to form an aerospace ball end.
